(19) United States
(12) Patent Application Publication
(10) Pub. No.: US 2011/0247751 A1
(43) Pub. Date: Oct. 13, 2011

(54) METHOD AND DEVICE FOR PRODUCING COMPOSITE MATERIAL COMPONENTS AND CONTACT PRESSURE UNIT

(75) Inventors: Martin Steyer, Breinig (DE); Sebastian Schmitz, Aachen (DE); Patrick Koizer, Brendorf (DE)

(73) Assignee: FRAUNHOFER-GESELLSCHAFT ZUR F?RDERUNG DER ANGEWAND, Muenchen (DE)

(21) Appl. No.: 12/998,113

(22) PCT Filed: Sep. 18, 2008
(86) PCT No.: PCT/DE2008/001551

§ 371 Date: Jun. 3, 2011

(51) Int. Cl. B32B 37/06; F28F 5/02

(52) U.S. Cl. 156/272.8; 156/380.9; 492/46

(57) ABSTRACT

In the case of a process for producing composite material components, thermoplastic prepreg tapes (1) are laid onto a laying surface of a composite material component (2) that is still to be completed, are heated by means of laser radiation (3) and are pressed by means of a pressure-exerting pad (4, 23) of an elastic-flexible material, for example an elastomer. The pressure-exerting pad (4, 23) has a low absorption to the laser radiation (3). This may be achieved, for example, by a translucence of the pad material (6) along with a low absorption coefficient or by a reflective surface. A constant contact pressure is achieved by means of a fluid located in the pressure-exerting pad (4, 23). The internal pressure of the pressure-exerting pad (4, 23) may be controlled to a constant value. Moreover, the pressure-exerting pad (4, 23) may be cooled by means of the fluid.

The invention relates to a process for producing composite material components in which a first workpiece is fixed on a second workpiece, the workpieces being pressed against each other at the connecting location by means of a pressure-exerting unit that has an elastically flexible pressure-exerting pad. Furthermore, the invention relates to a device for producing composite material components, comprising a pressure-exerting unit with an elastically flexible pressure-exerting pad, and to a pressure-exerting unit.

High-performance fibre composite components have become established in many application areas, for example in aeronautical and aerospace engineering, and are particularly suitable wherever low weight is required at the same time as a high mechanical load-bearing capacity. The high-performance fibre composite components are created by laying continuously fibre-reinforced thermoplastic prepregs. Prepreg (preimpregnated fibres) is the term used for a semifinished product comprising continuous fibres and a polymer matrix. However, particularly because of the high production costs, this material technology is not being used very much at present. In the prepreg laying process, usually prepreg tapes are advanced, pressed onto a mould, automatically laid and cut after laying. To produce sheet-like components, a number of prepreg tapes are laid next to one another in an abutting fashion. The thickness of the component is produced by laying a number of layers one on top of the other. In this way, local reinforcements of the component can also be achieved.

DE 690 05 392 T2 discloses a process and a device of the type mentioned at the beginning. Accordingly, for the production of composite material components, material in tape form, for example, is laid onto a laying surface of a still unfinished component. At the same time, the laid material is pressed onto the laying surface by a pressure-exerting unit. To be able to carry out sufficient and uniform pressing even in the case of complex surfaces, for example with concave or convex regions, a pressure-exerting unit with a flexible-elastic pressure-exerting pad, consisting for example of elastomer, is used. The elastomer is mounted directly on a shaft, which is likewise elastic transversely to the longitudinal axis. This allows concave or convex surface regions of the composite material component to be worked.

However, it is disadvantageous that the elastomer used for the circumferential material of the pressure-exerting unit only has a low temperature resistance. In the case of a silicone rubber, as used by the applicant, to be specific that sold at the time of the application by Wacker Chemie AG Wacker-Silicone, Munich, under the designation ELASTOSIL® RT 625, the mechanical properties of the material are no longer sufficient to allow the desired pressing at temperatures above 215° C. Specifically when laying thermoplastic material, however, it is generally heated to temperatures above the aforementioned limit. Use of the known pressure-exerting unit with the process disclosed in the prior art is therefore possibly suitable for thermosetting prepregs, but not for thermoplastic prepregs.

Further disadvantages arise when there are unevennesses in the surface to be worked, the spatial extent of which is much less than that of the longitudinal axis of the pressure-exerting unit. Then the known pressure-exerting unit cannot act with a uniform contact pressure on a surface with alternating convex and concave regions. But even in the case of purely convex surface regions, locally different contact pressures may be produced in the pressing process. This is so because, wherever the elastomer of the circumferential material is pressed together more because of the unevenness, a higher pressure is also produced locally. In the case of highly concave surface regions, there may be hollow regions that are not reached by the pressure-exerting pad, or only with insufficient contact pressure, in spite of the flexibility of the pressure-exerting pad and the roller. However, significant differences in contact pressure within a contact line, running parallel to the axis of rotation of the pressure-exerting pad, between the pressure-exerting pad and the prepreg tape are undesired.

DE 10 2006 058 097 A1 likewise discloses a process and a device of the type mentioned at the beginning. Disclosed there on the one hand is a pressure-exerting unit with a fixed roller, which has on its outer circumference a geometrically adaptive overlay of an elastic plastic. The flexibility is restricted, since the thickness of the layer of plastic is relatively small in comparison with the circumference of the roller. The pressure-exerting unit can be cooled by means of a fluid flowing through the roller. Contact between the fluid and the layer of plastic is not disclosed.

On the other hand, DE 10 2006 058 097 A1 discloses a pressure-exerting unit which has a multiplicity of ferromagnetic annular plates, which are mounted parallel to one another and next to one another and may each have an elastic overlay on their circumference. An electromagnetic field forces the plates in the direction of the prepreg layer to be consolidated. Since the plates are movable with respect to one another, the surface defined by the plates adapts itself to the form of the prepreg. It is disadvantageous here that, in the case of a curvature, the surface defined by the plates must be of a stepped form, on account of the lateral extent of the individual plates, and consequently complete adaptation to a curved profile is not possible. Moreover, the pressure exerted locally by the plates on the prepreg layer to be consolidated also depends on the interaction between neighbouring plates and, for example due to undesired disturbances in the friction between neighbouring plates, may lead to harmful differences in pressure along the contact line between the pressure-exerting unit and the prepreg layer. The manner in which the prepreg material is heated is not divulged.

EP 0 167 377 A2 discloses a process and a device for laying fibre-reinforced tapes. In this case, the tape to be laid is heated by means of infrared radiation and pressed onto an already laid tape or onto an underlying surface by means of a rigid pressure-exerting roller. The infrared radiation is in this case directed onto the side of the tape to be laid that is facing away from the pressure-exerting roller, approximately onto the point of contact between the tape to be laid and the tape already laid/the underlying surface. The pressure-exerting roller is made of a solid material coated with Teflon, which is stable under the temperatures required. Consequently, the fibre-reinforced tape can only be reliably consolidated in a plane. Adaptation of the pressure-exerting roller to curved surfaces is not possible.

It is thus an object of the present invention to provide a process, a device and a pressure-exerting unit of the type mentioned at the beginning which do not have the aforementioned disadvantages, which therefore allow in particular laying of thermoplastic material with almost any desired geometries and with a pressure distribution of the pressure-exerting pad that is as homogeneous as possible.

In the case of a process of the type mentioned at the beginning, the object is achieved by the features of the characterizing part of claim 1.

The laser radiation allows the material that is to be laid, or else the laying surface of the component, to be heated in a specifically directed manner, both with regard to the temperature to be reached in the workpiece and also geometrically. In this respect, it is advantageous to direct the laser radiation onto the side of the first workpiece, arranged between the pressure-exerting unit and the second workpiece, that is facing away from the pressure-exerting unit. This achieves the effect that the side of the first workpiece that is facing the pressure-exerting pad is heated to a lesser degree and excessive heating of the pressure-exerting pad via the workpiece to be laid is avoided. Since, however, the peripheral regions of the first workpiece must also be heated sufficiently, it is generally unavoidable that part of the laser radiation passes by the workpiece and impinges directly on the pressure-exerting pad. A harmful effect of the laser rays on the pressure-exerting pad is then largely avoided by the protection of the pressure-exerting pad, making it possible for the first time to combine a pressure-exerting pad that has an elastic-flexible surface material with laser irradiation for heating the workpiece material.

Protection of the pressure-exerting pad may be provided, for example, by the pressure-exerting pad being shielded from the laser radiation. A wall that is not transparent for the laser radiation that is used may be used for this, arranged between the laser source and the pressure-exerting pad and allowing the first workpiece that is to be laid to pass through it. This may be accomplished by a gate-like or slit-like opening, the wall element being adaptable to different geometries of the first workpiece to be laid or completely exchanged to obtain the adaptation.

As an alternative or in addition to the shielding, the process may be carried out with a pressure-exerting pad which is translucent for the laser radiation that is used, at least in a region that is exposed during the use of the laser radiation. This means that at least part of the impinging radiation passes through the pressure-exerting pad, and consequently does not make it heat up. It may be advantageous in this respect that the material chosen for the pressure-exerting pad is a material of which the absorption coefficient for the laser radiation that is used is at most 0.8. Lower absorption coefficients, for example at most 0.5 or at most 0.3, are correspondingly even more advantageous. However, the absorption coefficients mentioned are also advisable in the case of non-translucent material that absorbs part of the incoming radiation and sends the rest back, for example by diffuse scattering.

Furthermore, the pressure-exerting pad may also be protected from the laser radiation by at least a region that is exposed to the laser radiation during use being reflective for the laser radiation that is used.

Furthermore, it is advantageous to provide a fluid in the pressure-exerting pad. The fluid may be used for cooling the pressure-exerting pad, so that there is further protection from undesired heating. The fluid may be controlled to a constant temperature value during the exertion of pressure in the pressure-exerting pad. The fluid filling of the pressure-exerting pad may consist, for example, of air or a liquid, such as oil.

A further advantage of the fluid is that the pressure-exerting pad exerts a uniform pressure on the workpiece to be laid over virtually the entire contact area. This also applies in particular in the case of surfaces that are not planar. If, for example, a convexly curved region of the prepreg surface is pressed into the pressure-exerting pad, and possibly reduces the volume thereof, the increased pressure produced as a result is distributed uniformly over the entire pressure-exerting pad.

Therefore, as a result of the fluid, the internal pressure is always homogeneously distributed locationally, but it is not necessarily constant over time. Controlling the internal pressure of the pressure-exerting unit allows constancy of the internal pressure of the pressure-exerting pad over time also to be achieved. In this way, the contact pressure along the contact line, running parallel to the axis of rotation of the pressure-exerting pad, of the maximum contact pressure between the pressure-exerting pad and the prepreg tape is also constant over time.

The cooling of the fluid may take place outside the pressure-exerting pad. In this case, cooling of the material of the pressure-exerting pad is also achieved by a constant exchange of the fluid located in the pressure-exerting pad. In a corresponding way, the pressure-exerting pad can also be heated. This may be advisable, for example, if other protection from the laser radiation, for example by shielding, is sufficient and a heated pressure-exerting pad is advantageous for the pressing process. The temperature may be controlled to a desired value both for cooling and for heating.

The aforementioned object is achieved in the case of a device of the type mentioned at the beginning by the characterizing features of claim 8.

Advantageous configurations of the device are provided by claims 9 to 20.

Composite materials can be produced from a wide variety of materials. The frequencies of the laser radiation that is used, and the intensity thereof, that are optimal for the heating are dependent on the materials involved and for this reason are predetermined. If a material that is translucent or partially absorbent for the laser radiation that is used is intended to be used for the pressure-exerting pad, it is possible for a person skilled in the art to determine a surface material suitable for the pressure-exerting pad, by calculating or estimating the thermal energy taken up by the pressure-exerting pad and consequently the temperature locally occurring there, from the absorption coefficient, the impingement area of the laser radiation on the pressure-exerting pad, the irradiating time and the energy density of the laser radiation that is used. Consequently, said person can readily choose a surface material with a suitable absorption coefficient. It is often advantageous to choose for the electromagnetic radiation that is used an absorption coefficient that is at most 0.5, in particular at most 0.3.

With the following combination of materials and process parameters it has been possible to keep the temperature of the pressure-exerting pad to below 130° C. The pressure-exerting unit, which is formed as a roller and the pressure-exerting pad of which, made of ELASTOSIL® RT 625 (of the Wacker Chemie company), has a diameter of 80 mm, is moved during use at a speed of 0.5 m/s in relation to the workpiece to be covered, while the prepreg to be laid, with a width of 6.3 mm, is irradiated with a high-power diode laser (wavelength 808 nm) having a focal spot of 11 mm×40 mm and an area coverage of about 4 W per mm². Half of the focal spot, i.e. over a length of 20 mm, impinges on the workpiece to be covered and the other half impinges on the prepreg and additionally on the pressure-exerting pad. Consequently, two partial areas of the focal spot of a total of about 4.7 mm×20 mm reach the pressure-exerting pad. The absorption coefficient of the material of the pressure-exerting pad was 0.2. The prepreg was a matrix of PEEK (polyetherether ketone) provided with standard carbon fibres and of a thickness of 0.1 mm.

In a further pressing process, a pressure-exerting pad of a diameter of 60 mm was used and the roller was moved at a speed of 0.1 m/s. The other process parameters remained unchanged. Here, the temperature of the pressure-exerting roller remained below 180° C.

The device according to the invention may also be formed in such a way that the pressure-exerting pad consists at least partly of an elastomer or of some other material that has elastomeric properties at the temperature range envisaged during use. In this case, the material of the pressure-exerting pad may in particular be silicone. Alternatively, polyurethanes may also be used for the material of the pressure-exerting pad. What is important is the elastic flexibility of the material. Elastic refers here to any material which has a modulus of elasticity below 40,000 N/mm² at a material temperature of 23° C., or which behaves like an elastomer at room temperature and/or the temperatures prevailing during the use of the pressure-exerting pad.

In a claimed variant, the pressure-exerting unit comprises a single roller element having the pressure-exerting pad. Alternatively, the pressure-exerting unit may, however, also have two or more roller elements lying one behind the other in the direction of advancement and enclosed by the pressure-exerting pad. As a result, the pressure-exerting unit is given a caterpillar-like structure. Here it is advantageous that, unlike in the case of a single roller element, workpieces are not just pressed essentially over a line of an only small extent more or less in the direction of advancement, but instead the contact pressure can be maintained over a certain pressing area that is extended in the direction of advancement. Also in the case of this embodiment, the pressure-exerting pad may be fluid-filled, the connection for the supply and removal of the fluid being taken along during the movement of the pressure-exerting pad. Consequently, an exchange of the fluid, and consequently the control of the pressure and/or the control of the temperature of the pressure-exerting pad that is carried out by means of the fluid, is also possible during the advancement and pressing.

At least the front roller element in the direction of advancement may likewise have a flexible-elastic circumferential material. If the outer pressure-exerting pad is at least partly translucent, a translucence and/or at least a low absorption coefficient—as described above for the pressure-exerting pad—may also be provided for the roller elements, in order to protect the roller from an increase in temperature caused by impingement of the laser radiation. The roller elements, or else just one of them, may likewise be fluid-filled and be cooled or heated by means of the fluid, if necessary also with temperature control. A pressure control may also be provided.

Furthermore, the aforementioned object is achieved in the case of a pressure-exerting unit with an elastically flexible pressure-exerting pad by the characterizing feature of claim 21. Advantageous configurations are provided by claims 22 to 26. The fluid filling of the pressure-exerting pad provides an effective cooling capability. Moreover, the pressure uniformly distributed in the pressure-exerting pad as a result of the fluid filling provides a correspondingly locally uniformly distributed pressing force. In the case of the pressure control, a pressure that is constant over time is also achieved. Otherwise, reference is made to the statements made with respect to the device according to the invention that concern the pressure-exerting pad. The pressure-exerting unit may also be used in the case of processes and devices for producing composite material components without the use of laser radiation.

A preferred embodiment of the process according to the invention as well as an embodiment of the device according to the invention and of the pressure-exerting unit according to the invention are presented below with reference to the schematic figures, in which:

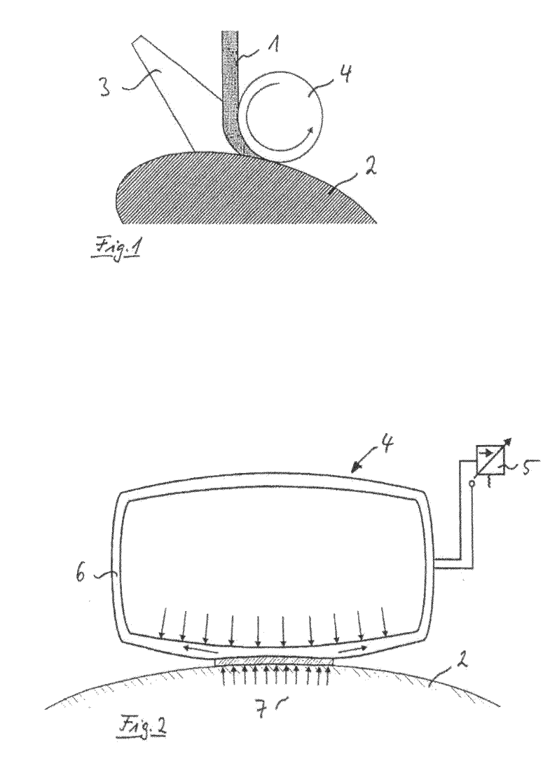

FIG. 1 shows a pressure-exerting unit in lateral cross section, during the pressing of a prepreg tape onto a support,

FIG. 2 shows a pressure-exerting unit in longitudinal cross section, during use, and

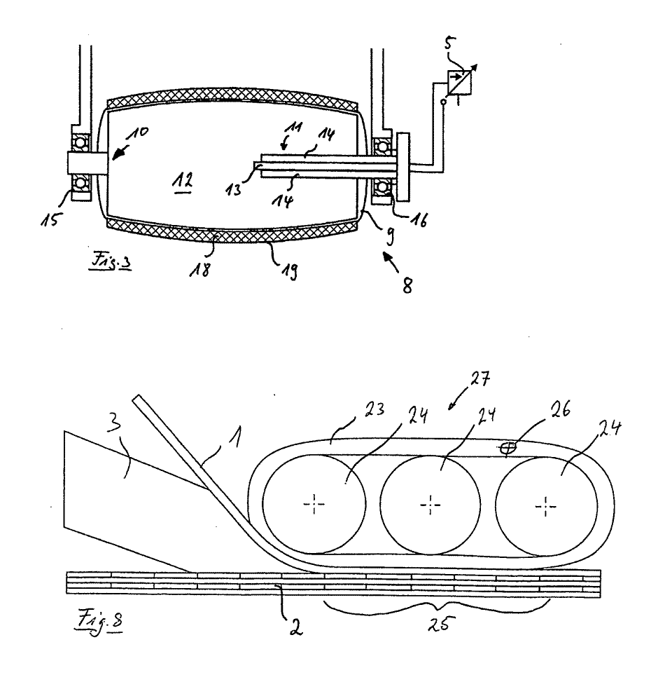

FIG. 3 shows a pressure-exerting unit in longitudinal cross section,

FIG. 4 shows a pressure-exerting unit in lateral cross section, during the pressing of a prepreg using a laser screen,

FIG. 5 shows the arrangement according to FIG. 4 in a rear view,

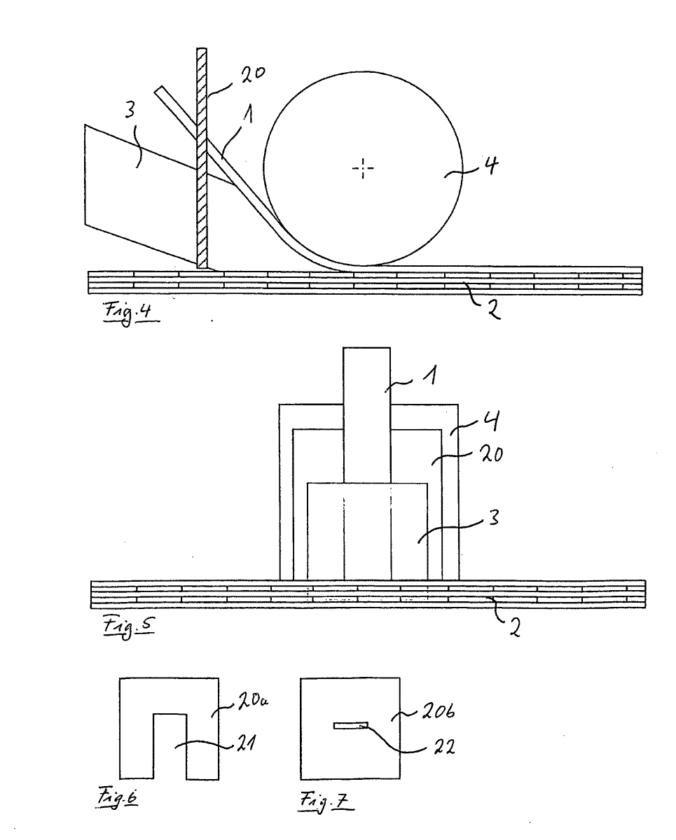

FIG. 6 shows a laser screen in a first configuration,

FIG. 7 shows a laser screen in an alternative configuration with a slit and

FIG. 8 shows a caterpillar-like pressure-exerting unit in lateral cross section, during the pressing of a prepreg onto a support.

FIG. 1 schematically shows a prepreg tape 1, which is laid on the surface of a composite material component 2. For this purpose, the prepreg tape 1 and the composite material component 2 are heated by means of a laser beam 3 from a laser beam source not represented here. On the side of the prepreg tape 1 that is facing away from the laser beam source, a pressure-exerting pad 4 presses the prepreg tape 1 onto the composite material component 2. For this purpose, the pressure-exerting pad 4 rotates in the direction of the arrow about a shaft not represented in FIG. 1. The pressure-exerting pad 4 consists of silicone rubber and must not exceed temperatures of 215° C. Otherwise, the silicone melts and loses its properties that are necessary for the process. On account of the irradiation of the prepreg tape 1 from the underside, it is possible with a suitable laying rate to achieve the effect that, although the prepreg tape 1 reaches on its underside the temperature necessary for the desired connection between the prepreg tape 1 and the composite material component 2, the side of the prepreg tape 1 that is in contact with the pressure-exerting pad 4 remains well below the temperature that is critical for the pressure-exerting pad 4.

Since the prepreg tape 1 must be acted on uniformly by the laser radiation 3 over its entire width, it is not possible to prevent laser radiation from passing by the prepreg tape 1 and impinging directly on the pressure-exerting pad 4. It must therefore be prevented that the laser radiation 3 heats the pressure-exerting pad 4 above the critical temperature. For this purpose, the pressure-exerting pad 4 is made translucent for the laser radiation 3 that is used, with an absorption coefficient of 0.2. Alternatively, the pressure-exerting pad 4 may also be provided with a reflective surface.

FIG. 2 schematically shows a pressure-exerting pad 4 in cross section, in the laying direction. The composite material component 2 is convexly curved parallel to the axis of rotation of the pressure-exerting pad 4. The pressure-exerting pad 4 is filled with compressed air, the pressure of which is controlled by means of a pressure-limiting valve 5. Alternatively, a pressure control valve may also be used. The pad material 6 is, for example, silicone rubber and is consequently flexibly elastic. This allows the pressure-exerting pad 4 to adapt itself optimally to the profile of the surface of the composite material component 2. As a result of the pressure control, there is a constant internal pressure for the pressure-exerting pad 4 at any time. Consequently, the contact pressure that the pressure-exerting pad 4 exerts on the surface of the prepreg tape 1 along the contact line identified by the arrows 7 is largely constant over time over the entire width that acts on the prepreg tape 1. This contact line of maximum contact pressure moves over the prepreg tape 1 as the pressure-exerting pad 4 advances.

FIG. 3 shows a detail of a pressure-exerting unit 8 with a pressure-exerting pad 9, which is fixed to two shafts 10 and 11. The pressure-exerting pad 9 has an air chamber 12, which is supplied with compressed air by means of an air supply line 13. Laid in an annular form around the air supply line 13 is an air removal line 14. The air supply line 13 and the air removal line 14 together form the shaft 11. The shafts 10 and 11 are mounted rotatably in ball bearings 15 and 16. A system (not represented in its entirety) for controlling the compressed air in the air chamber 12 comprises a pressure-limiting valve 5.

In FIG. 3, the pressure-exerting pad 9 comprises a base material 17, for example of silicone. Applied on the lateral surface of the base material 17 is a layer of rubber 18 and applied in turn on the outer lateral surface of the layer of rubber 18 is a metal fabric 19. The metal fabric 19 serves for limiting the expansion of the pressure-exerting pad 9. Moreover, the surface can be made reflective by means of the metal fabric 19.

FIG. 4 shows a variant of the process and of the device with shielding of the laser beam 3. Arranged between the pressure-exerting pad 4 and the source (not represented) for the laser radiation 3 is a laser screen 20, which ensures that no laser radiation, or as little as possible, can pass by the prepreg tape 1 to be laid and reach the pressure-exerting pad 4. FIG. 5 shows the arrangement from the direction of the laser source (not represented).

FIG. 6 shows a form of laser screen 20a with a gate-like opening 21 for the prepreg tape 1 to pass through. FIG. 7 shows an alternative form of laser screen 20b, with a slit-shaped opening 22, through which the prepreg tape 1 is passed. The laser screens 20 can be easily exchanged, making adaptation to different geometries of prepreg tape possible. Alternatively, variable laser screens may also be used.

FIG. 8 shows a pressure-exerting unit 27 with a pressure-exerting pad 23, which is made to extend around three roller elements 24. This creates a pressing area 25, which is extended considerably in comparison with that of a pressure-exerting pad made to extend over a single axis, which may be advantageous for the pressing process. The pressure-exerting pad may consist of a solid material or else be fluid-filled. In the case of a fluid filling, the interior of the pressure-exerting pad 23 may be supplied by means of a fluid connection 26. By means of a supply tube that likewise runs along with said pad but is not represented, the pressure of the fluid that prevails in the interior of the pressure-exerting pad, or the temperature thereof, can be changed, and also controlled, by means not represented here that are located outside the pressure-exerting pad 23.

The properties of the pressure-exerting pad 23 may correspond to those of the single-axis pressure-exerting pad represented in FIGS. 1 to 7 with regard to translucence or reflection and/or absorption coefficient. In the case of an at least partly translucent pressure-exerting pad 23, at least the forwardmost roller element 24 may likewise be provided with a small absorption coefficient, in order to protect the roller element 24 from a temperature increase as a result of the impinging laser radiation 3.

Some or all of the roller elements 24 may consist of an elastic-flexible material and/or be fluid-filled. Here, too, cooling or heating and control of the temperature and/or the pressure can be performed by means of the fluid. However, the rollers may also consist of a solid material. During the pressing, the pressure exerted by the pressure-exerting pad 23 on the prepreg tape 1 to be laid may be lowered slightly in the regions between the roller elements 24, since there the roller elements 24 are not directly in contact. The variance in the contact pressure can be reduced by choosing correspondingly small diameters of the roller elements 24.

### LIST OF DESIGNATIONS

1. Prepreg
2. Composite material component
3. Laser radiation
4. Pressure-exerting pad
5. Pressure-limiting valve
6. Pad material
7. Arrows
8. Pressure-exerting unit
9. Pressure-exerting pad
10. Shaft
11. Shaft
12. Air chamber
13. Air supply line
14. Air removal line
15. Ball bearing
16. Ball bearing
17. Base material
18. Layer of rubber
19. Metal fabric
20. Laser screen
21. Gate-like opening
22. Slit-like opening
23. Pressure-exerting pad
24. Roller element
25. Pressing area
26. Fluid connection
27. Pressure-exerting unit

1-26. (canceled)

27. Process for producing composite material components in which a first workpiece (1) in tape form is fixed on a second workpiece (2), the workpieces (1, 2) being pressed against each other at the connecting location by means of a pressure-exerting unit (8, 27) that has an elastically flexible pressure-exerting pad (4, 23), is formed as a roller and is moved in a rolling manner in relation to the second workpiece (2),
the workpiece (1) in tape form being heated on its side facing away from the pressure-exerting unit (8, 27) by means of laser radiation (3) and
the pressure-exerting pad (4) being protected from the direct influence of the laser radiation (3) in such a way that the temperature of the pressure-exerting pad (4, 23) is not increased above a value that is critical for the pressing process,
characterized in that the pressure-exerting pad (4, 23) is made such that at least a region of the pressure-exerting pad (4, 23) that is exposed to the laser radiation (3) during use has for the laser radiation (3) that is used an absorption coefficient of at most 0.5, preferably at most 0.3.

28. Process according to claim 27, characterized in that a pressure-exerting pad (4, 23) which is translucent for the laser radiation (3) that is used, at least in a region that is exposed to the laser radiation (3) during use, is used.

29. Process according to claim 27, characterized in that at least a region of the pressure-exerting pad (4, 23) that is exposed to the laser radiation (3) during use is reflective for the laser radiation (3) that is used.

30. Process according to claim 27, characterized in that the pressure-exerting pad (4, 23) is shielded from the laser radiation (3).

31. Process according to one of claims 27 to 30, characterized in that, during the pressing, the pressure of a fluid located in the pressure-exerting pad (4, 23) is controlled to a constant value.

32. Process according to claim 27, characterized the pressure-exerting unit (8, 27) is made to extend in a rotating manner around a shaft (10, 11) during use and in that the pressure-exerting pad (4, 23) is supplied with the fluid through the shaft (11).

33. Process according to claim 27, characterized in that, during the pressing, the pressure-exerting pad (4, 23) is cooled or heated by means of the fluid located in the pressure-exerting pad (4, 23).

34. Device for producing composite material components, comprising a pressure-exerting unit (8, 27) formed as a roller with an elastically flexible pressure-exerting pad (4, 23),
a laser radiation source (3) and protective means for protecting the pressure-exerting pad (4, 23) from an undesirably great influence of the laser radiation (3) up to the temperature of the pressure-exerting pad (4, 23) being provided,
characterized in that
as protective means, at least a region of the pressure-exerting pad (4, 23) that is exposed to the laser radiation (3) during use has an absorption coefficient for the laser radiation (3) that is used of 0.5, preferably at most 0.3.

35. Device according to claim 34, characterized in that as protective means, at least a region of the pressure-exerting pad (4, 23) that is exposed to the laser radiation (3) during use is translucent for the laser radiation (3) that is used.

36. Device according to claim 34, characterized in that at least the region of the pressure-exerting pad (4, 23) that is exposed to the laser radiation (3) during use is reflective for the laser radiation (3) that is used.

37. Device according to claims 34, characterized in that, as further protective means, means for shielding the pressure-exerting pad (4, 23) from the laser radiation (3) are provided.

38. Device according to claim 34, characterized in that the pressure-exerting pad (4; 23) consists at least partly of an elastomer or of some other material that has elastomeric properties at the temperature range envisaged during use.

39. Device according to claim 38, characterized in that the material of the pressure-exerting pad is silicone.

40. Device according to claim 34, characterized in that the pressure-exerting pad (4, 23) is filled with a fluid.

41. Device according to claim 34, characterized in that the pressure-exerting unit (8, 27) is made to extend in a rotating manner around a shaft (10, 11) during use and in that the pressure-exerting pad (4, 23) is supplied with the fluid through the shaft (11).

42. Device according to claim 40, characterized in that means (5) for controlling the internal pressure of the pressure-exerting pad (4, 23) exerted by the fluid are provided.

43. Device according to claim 40, characterized in that means for heating or cooling the fluid present in the pressure-exerting pad (4, 23) are provided.

44. Device according to claim 34, characterized in that the pressure-exerting unit (8) is a single roller element having the pressure-exerting pad (4).

45. Device according to claim 34, characterized in that the pressure-exerting unit (23) has at least two roller elements (24) lying one behind the other in the direction of advancement and enclosed by the pressure-exerting pad (23).

46. Device according to claim 45, characterized in that at least the front roller (24), seen in the direction of advancement, is in certain regions translucent or reflective for the laser radiation (3) that is used and/or has an absorption coefficient of at most 0.5, preferably 0.3.

47. Pressure-exerting unit formed as a roller, with an elastically flexible pressure-exerting pad (4),
the pressure-exerting pad (4) being filled with a fluid,
characterized in that means for heating or cooling the fluid present in the pressure-exerting pad (4) are provided.

48. Pressure-exerting unit according to claim 47, characterized in that means (5) for controlling the internal pressure of the pressure-exerting pad (4) exerted by the fluid are provided.

49. Device according to claim 47, characterized in that the pressure-exerting unit (8, 27) is made to extend in a rotating manner around a shaft (10, 11) during use and in that the pressure-exerting pad (4, 23) is supplied with the fluid through the shaft (11).

50. Pressure-exerting unit according to claim 47, characterized in that the pressure-exerting unit (8) is a single roller element having the pressure-exerting pad (4).

51. Pressure-exerting unit according to one of claims 47 to 49, characterized in that the pressure-exerting unit (23) has at least two roller elements (24) lying one behind the other in the direction of advancement and enclosed by the pressure-exerting pad (23).
